(19) United States
(12) Patent Application Publication
(10) Pub. No.: US 2010/0281430 A1
(43) Pub. Date: Nov. 4, 2010

(54) MOBILE APPLICATIONS SPIN MENU

(76) Inventor: SAMIR HANNA SAFAR, SAN DIEGO, CA (US)

Correspondence Address: SAMIR HANNA SAFAR, 13790 ROSECROFT WAY, SAN DIEGO, CA, 92130, US

(21) Appl. No.: 12/772,177

(22) Filed: May 1, 2010

Related U.S. Application Data
(60) Provisional application No. 61/174,987, filed on May 2, 2009.

(51) Int. Cl. G06F 3/048

(52) U.S. Cl. 715/834; 715/835

(57) ABSTRACT

A mobile communication system and a process of organizing applications (2) by category in simple form access menu. The process envisages displaying menu in a disc format (3) for each category menu items. The user is allowed to slide by touch his application (2) to any category disc (3) and the applications (2) in each category disc (3) will be displayed in a pie shape (5). The user can further rotate the disc (3) by touch which will result in the display of more menu items (2) on the mobile touch screen display unit (1).

### FIELD OF INVENTION

The present invention relates to the field of mobile communication systems and more particularly relates to a system and process of displaying menu in the screen such that it looks like a disc and organizing applications by category. Further, the invention relates to a system and process in which the user can easily access the menu by spinning the menu disc which is displayed in the screen.

### BACKGROUND OF THE INVENTION

Mobile devices have gained wide popularity and are widely used because of their mobility and convenience of communication functions and facilities they are providing. The qualities of mobile terminals has been increased in size, design, resolution and user interface and are providing many additional functions now besides the basic call service function such as internet, send and receive voice and text messages, perform scheduling tasks, games, capturing images and video via a camera, recording audio, playing music files via a speaker system, displaying images and video on a display screen and multimedia service.

Recently, mobile terminals have been configured to receive broadcast and multicast signals which allow a user to view videos and television programs. Particularly, with the function for using multimedia or photograph service provided in the mobile communication terminal, a demand is sharply increasing for a color liquid crystal display. As use of such color mobile communication terminals spreads, interest in mobile user interface design is increasing.

As part of the increasing trend, an attempt to apply a touch screen to the mobile terminal has been made. A touch screen performs a function of an input device and a function of a display device thus allowing for the inputting and displaying of data on a single screen. Because of this feature, a mobile terminal may not require a keypad. However, there remains further opportunity for improving user convenience with regard to a touch screen in a mobile terminal.

Mobile terminals have attained worldwide popularity as a necessity for people of all ages. Mobile terminals are now becoming smaller, sleeker and lighter to improve portability, and are also implementing various multimedia functions and services. In particular, mobile terminals are changing to become multifunctional, multipurpose and multimedia devices. Mobile terminals are expected to be modified to meet various multimedia and Internet environments.

The new features set new demand on the usability of mobile terminals since the mobile terminals include a plurality of menu options the users use to perform a desired task. In order to accommodate the various functions added to mobile terminals, various hardware or software improvements have been considered. As an example, user interface (UI) environment improvements have been considered so as to enable a user to easily and conveniently search for or select a function of the mobile terminal. Furthermore, attempts have been made to provide features that allow a user to personalize their devices. One important usability issue is to provide a trend in displaying and controlling menu options. Therefore it is of great importance to provide an easy and perceptive menu displaying method.

CN Patent 1811686 (A) provides a handset panel distribution, which contains displaying handset operation system operation system taskbar at the lowest part of handset touch screen, displaying current task window heading menu tool bar at the top part of handset touch screen, heading menu tool bar integrating title bar, menu bar, and tool bar on a unified operating interface.

DE Patent 19855022 (A1) comprises a keyboard and a display below the keyboard on the front side of the telecommunications unit. There is at least one extra input apparatus at the unit rear side. The extra input may be a track ball, a wheel, a rotary disc, a roller, a coordinate slider, a three-dimensional track pad and/or a joystick at the unit rear side. The display is single- or multiline liquid crystal display (LCD) or graphic.

CN Patent 1505428 (A) claims a kind of browsing method of mobile phone list that arranges several images into a series, and designates one image in the series on the screen of the mobile phone; the image is correspondent one item in the list. Following, receives a direction signal, the images at front of or back of the selected one with a fixed amount are displayed on the screen, and maintains to display the last one; if the signal is an affirmation signal, connects to a page of the correspondent screen.

U.S. Pat. No. 7,346,373 details a device for organizing a menu in a mobile communication terminal. The device comprises a control unit for dynamically generating and deleting a plurality of menu planes according to a user's setting, each plane including at least one menu item; a control unit for providing a mechanism of multi-dimensional navigation between the generated menu planes; and a display unit for receiving the menu planes from the control unit and displaying the received menu planes under control of the control unit.

CN Patent 101252746(A) describes a method of displaying a menu in a mobile communication terminal and a mobile communication terminal. The method of displaying a menu in a mobile communication terminal comprises displaying a standby screen in a display of the mobile communication terminal, selecting one of a plurality of specific directions through an input device of the mobile communication terminal, and displaying each menu corresponding to the selected specific direction on the standby screen.

CN Patent 010287230(A) provides a mobile communication terminal and a menu display method. The mobile communication terminal comprises a radio frequency unit, a baseband circuit, an MCU control circuit, a keyboard and a display, and further comprises a judging unit used for judging whether the contents of chosen menus are too much or not, a rolling display unit used for displaying the contents of the menus in a rolling way when the judging unit judges that the contents of the chosen menus are too much. The embodiment of the invention has the beneficial effects that the clients can conveniently and rapidly understand the contents of the menus and information of the mobile communication terminal.

US Patent 2008297485(A1) discloses a device and a method for executing a menu in a mobile terminal are provided. The device for executing a menu in a mobile terminal includes a display unit for displaying, when a request for displaying a menu list is input, the menu list, including at least one menu, in a first direction and an item list, including at least one item, for executing the menu in a second direction intersecting the first direction, a touch panel for detecting a touch action on the display unit, a position detection unit for detecting, when the touch action is detected, a touch position on the display unit and a menu execution unit for determining a menu of the menu list in the first direction and an item of the item list in the second direction by analyzing the touch position and for executing the determined menu using the determined item. The device and method provide increased convenience to a user of a touch screen.

US Patent 2009031253(A1) claims a method for displaying icons on a portable device. The method includes displaying a first icon group including at least one icon on a touch screen of the portable device, wherein at least one icon of the first icon group is selectable responsive to a detected presence of an input at a location proximate to a displayed location of the at least one icon, and displaying a second icon group including at least one icon on the touch screen, wherein the at least one icon of the second icon group is selectable responsive to user contact with a mechanical input device, and wherein the selection of the at least one icon of the second icon group causes the first icon group to be displayed.

KR Patent 20020080538(A) discloses a system for selecting a display menu of a mobile phone and a method to employ a graphic user interface system on an LCD (Liquid Crystal Display), so as to implement graphical menus. A graphic user interface forms various icons thereon in order to display menu information. A moving unit moves a pointer from an icon activated on the graphic user interface to another icon. A menu information activating part locates the pointer moved by the moving unit on an icon and clicks the icon to activate the icon. And the moving unit uses one of a joystick, an arrow key and a jog key. That is, when desired icons selected with the arrow key, a selected item or command corresponding to the icon of an item indicated by the pointer is performed, thus easily selecting menus of a mobile phone with one hand.

However the purpose and methodology of all existing prior art do not address several issues. For example, various menu icons may be displayed on a display screen and each menu icon may perform one of the various functions associated with the mobile terminal. However, the various menu icons often cause confusion to a user of the mobile terminal. As the mobile phones become more and more compact, the operations through keys may cause typing error problems. These conventional user interfaces often result in complicated key sequences and menu hierarchies that must be memorized by the user. In addition, as the number of pushbuttons has increased, the proximity of neighboring buttons often makes it difficult for users to activate a desired pushbutton.

Again in the conventional mobile terminal, the menu lists are displayed on the display screen in the form of a bar-type list or a matrix-type list and menu navigation needs to be performed by pressing different types of buttons. However, all menu items cannot be shown on the display area at one time due to the limited amount of space on the screen and besides, if sub-menus are to be displayed, the main menu items are not shown, thus causing inconvenience to the user.

Further other conventional terminals provides a method of displaying the main menu together with sub-menus in two separate display screens with one screen showing the main menu and the other showing the sub-menus items. The user can view both screens, but menu navigation should be done separately for each screen which increases eye fatigue, requires more concentration and requires more hand-eye coordination on the part of the users.

Again the user finds the desired menu portion or item using the navigation key after moving through the menus, searching an address list by clicking the navigation key repeatedly and finally clicks a function key to implement a desired function in that desired menu. This process of repeatedly clicking the navigation key is monotonous, waste of time and user inconvenience.

Again in the conventional mobile terminals providing touch screens, good aim is required to correctly hit a desired icon. The wrong application may be launched if the user's aim is off or if he taps the empty desktop or between icons. In other systems the user may not have the cursor on an icon when he clicks the key. Because of the cursor location failure on the displayed icons, the mobile may display unintended application. Moreover, the size of the sensing zone is represented by a default size, without taking into consideration the habitual- or usual-keypad usages of the user which also leads to difficulties on the part of the user.

Generally, in conventional systems the mobile terminal has a tile structured menu screen which is divided into a menu selection part composed of icons and a function display part to display the function of a selected menu item. With this conventional menu screen, a shift between the menu items and an indication of the current position are performed only by means of the selecting layer, thus the menu screen has a low visibility.

Further limitations and disadvantages of conventional and traditional approaches presented in the above prior art will become apparent to one of skill in the art, through comparison of such systems with some aspects of the present invention as set forth in the remainder of the present application with reference to the drawings.

Therefore, there is need to provide a mobile terminal which allows convenient selection of menu items and easy access to selected menu items in a desirable manner. The present invention helps address the above drawbacks in the existing systems and differs from the existent prior art in that it provides a process of displaying spin menu through which easy access to menu applications can be available to the users.

It will be apparent to those skilled in the art that the objects of this invention have been achieved by providing mobile terminal with a spin menu, which is unique in nature, unlike existing menu selection models in mobile terminals that are suited only for limited purposes. Various changes may be made in and without departing from the concept of the invention. Further, features of some stages disclosed in this application may be employed with features of other stages. Therefore, the scope of the invention is to be determined by the terminology of the following description, claims, drawings and the legal equivalents thereof.

### SUMMARY OF THE INVENTION

This invention may be summarized, at least in part, with reference to its objects.

It is therefore a primary objective of the present invention to provide a system and process to facilitate menu selection by displaying menu items in discs on the mobile display screen and each disc displayed on the mobile display screen contains one category including but not limited to SMS, Travel, News, Food, Social, Web Search and Games.

Another objective of the present invention is to provide a system and a process whereby the users can assign or enter the category name as they like in the menu disc displayed on the screen.

Another objective of the present invention is to provide a system and a process of displaying and controlling menu items and make users possible to organize and slide applications to the categories of the menu disc according to their personal preferences.

Another objective of the present invention is to provide a system and a process whereby the applications slided in the desired category will be displayed on the mobile menu disc in a shape which is more appealable and convenient to access, to the users including but not limited to Pie shape.

Another objective of the present invention is to provide a system and a process of controlling the menu items by rotating the menu disc which is provided in a touch-panel on the display screen.

Another objective of the present invention is to provide a system and a process such that when the user rotates the disc through the touch screen in the clock-wise or/and anti clock-wise directions, more applications will be displayed on the screen, then the user can select his desired application. Thus the menu disc is displayed as a spiral staircase, the user has to rotate the disc so as to move on to the next application.

Another objective of the present invention is to provide a system and a process whereby the users have the option to display discs individually or in a stacked format in the center of the mobile screen.

Another objective of the present invention is to provide a system and a process whereby after downloading a new application, an automatic option will be given to the users to add the downloaded application to the menu disc displayed on the screen.

A further objective of the present invention is to provide a system and a process whereby a new application can be added in the menu disc by selecting a desired category disc among the menu discs displayed on the screen and then sliding new application to that category disc as the user desires.

The invention described herein thus comprises a mobile communication system and a process of organizing applications by category in simple form access menu in a pie shape where applications can be retrieved by a spin type access. Further, it comprises a process of displaying menu in a disc format for each category menu items and allows the user to slide his application to any category disc.

The above summary is intended to illustrate exemplary embodiments of the invention, which will be best understood in conjunction with the detailed description to follow, and are not intended to limit the scope of the invention. Thus these and other objects of the present invention will be more readily apparent when considered in reference to the following description and when taken in conjunction with the accompanying drawings.

### DESCRIPTION OF THE DRAWINGS

FIG. 1 is a schematic diagram of the present invention which is used as reference for the following description and claims.

FIG. 2 is a schematic diagram of the working of the present invention.

FIG. 3 is a schematic diagram of the working of the present invention.

### DETAILED DESCRIPTION OF THE INVENTION

The following description is presented to enable any person skilled in the art to make and use the invention, and is provided in the context of particular applications of the invention and their requirements. The present invention can be configured as follows:

The present invention may involve novel systems and processes to implement the said invention. For example, although a series of processes may be described with reference to a diagram, the order of processes may differ in other implementations when the performance of one processes is not dependent on the completion of another processes. Further, non-dependent processes may be performed in parallel. Thus, the present invention is not intended to be limited to the embodiments shown.

The present invention can be configured as follows:

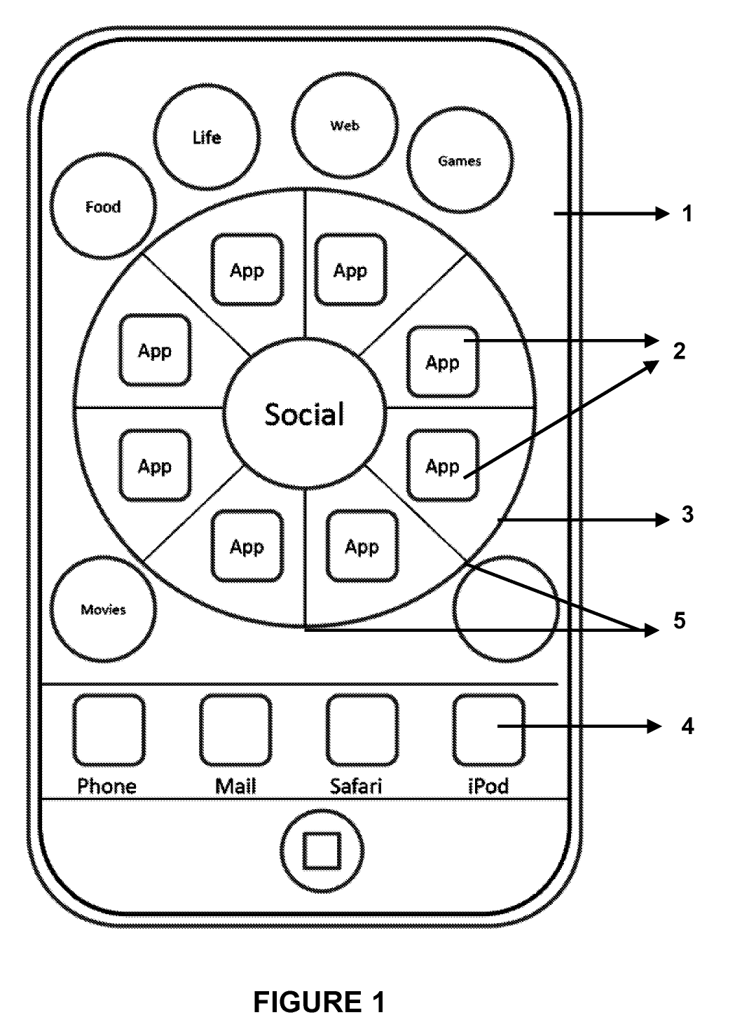

A mobile communication and system and a process of organizing applications and displaying spin menu, according to the invention, comprises of a system and process for displaying menu items in mobile terminal that consists of a display unit (1) for displaying, spin display of menu items (2) including at least one category of menu item for each disc (3) as displayed in FIG. 1. The invention allows the user to create up to 25 discs. The invention further allows the end-user to assign or enter the category name.

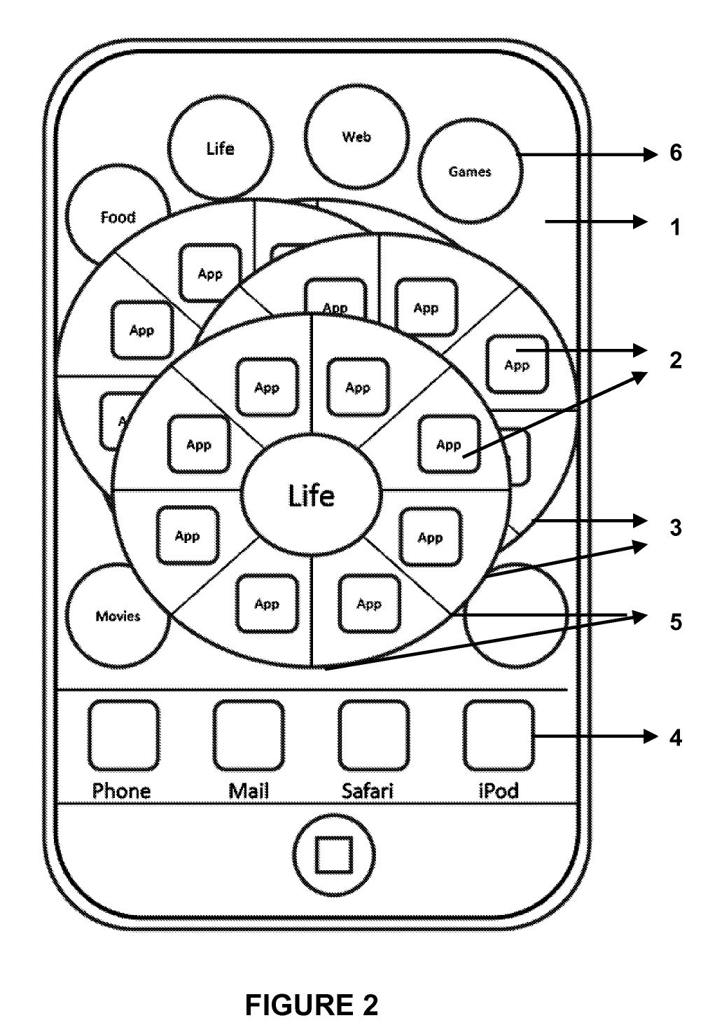

In another embodiment of this invention as depicted in FIG. 2, the user can slide his applications (2) to any category disc (3) according to his personal preferences and the category discs are provided in such a way that each disc can hold up to 200 applications (2). The invention also provides a process of displaying slided applications (2) on the disc (3) in pie shape (5).

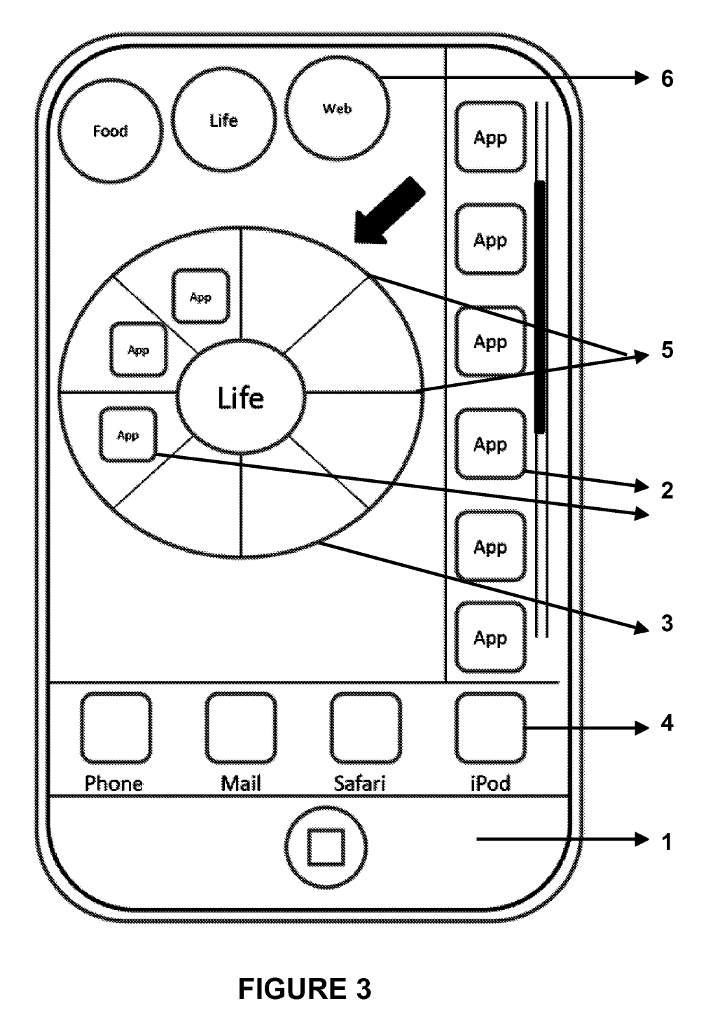

In another embodiment of the present invention as shown in FIG. 1, the system and process provides a fixed number of pies (5), but the pies (5) should be sized enough to display identifiable portions of the icon image (4). After the end-user creates a new disc (3) and gives it a category name, he should be able to slide the icon images (4) onto the pies (5) as shown in FIG. 3. In the same manner, the end-user can also be able to slide icons (4) off the pies (5).

In another embodiment of the present invention, the mobile terminal includes a process of rotating the menu list including the applications (2) by rotating the disc (3) the same way as that of the iPod control disc. The disc (3) in this invention behaves like a spiral stairs. As the disc (3) rotates more applications (2) appear and wherein the left rotation of the disc (3) provides forward movement of the disc (3) and the right rotation provides backward movement of the disc (3).

In another embodiment of the present invention, the user can avail the option to display the menu discs (3) individually as shown in FIG. 1 or in stacked format as depicted in FIG. 2 in the center of the mobile display screen (1). When the menu discs (3) are displayed individually, they become mini-discs (6). They are displayed around the main center disc as shown in FIG. 1 with showing only the category name. When the menu discs (3) are stacked on the center, the end-user has to slide the top disc off the screen so as to see the one below it, then the slided top disc is placed around the main disc (3) and becomes a mini-disc (6) and when the end-user touches the mini-disc, it comes into focus.

In another embodiment of the present invention, when the user downloads the Spin Menu applications, icon (4) copies of all applications on the mobile terminal will be lined up on the right hand side of a blank disk as shown in FIG. 3 and allows the user to enter the category name The user can then scroll up and down the icons (4), and slide the applications (2) on the category which he wants to go. He can avail the option to create a new category disc (3) on the mobile screen and continue to do the same process until he completes. He can also avail an option when he loads his applications (2) onto the disc (3) to make the Spin Menu his default application menu.

In another embodiment of the present invention, when the user completes downloading a new application, an automatic option will be given to him to add his downloaded application to the Spin Menu. If he opts for the same, the spin menu will appear on the mobile display and then he can select a disc (3) to slide that new application to that disc. If he does not want to add his downloaded application to the spin menu, his normal mobile display screen will come up. But he can add that application to the spin menu at anytime again.

The present invention comprises a mobile communication system and a process of displaying menu items on a mobile terminal having a disc format and includes displaying .a plurality of icons (4) and comprises a process of receiving user input responsive to user-driven rotation of a rotatable wheel located on the rear side of the mobile terminal, and selectively highlighting individual icons of the plurality of icons (4) responsive to the user-driven rotation of the wheel. Further the invention comprises a touch panel for detecting a touch on the display unit (1) and an execution unit for determining an icon (4) on the menu disc (3) and analyzing the touch position to execute the determined icon (4) and finally the display unit (1) which is provided with the selected menu display area for outputting information about the icon (4) selected from the menu disc (3).

Further it will be apparent to those skilled in the art that the objects of this invention have been achieved by providing the above invention. However various changes may be made in the structure of the invention without departing from the concept of the invention. Therefore, the scope of the invention is to be determined by the terminology of the above description and the legal equivalents thereof.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

I claim:

1. A mobile communication and system and a process of organizing applications and displaying spin menu comprising of a system and process for displaying menu items on a mobile terminal containing a display unit (1) for displaying spin display of menu items (2) including at least one category of menu item for each disc (3) a plurality of icons (4), a touch panel for detecting a touch on the display unit (1) an execution unit for determining an icon (4) on the menu disc (3) and analyzing the touch position to execute the determined icon (4) characterized in that said process includes receiving user input responsive to user-driven rotation of a rotatable wheel located on the rear side of the mobile terminal, and selectively highlighting individual icons of the plurality of icons (4) responsive to the user-driven rotation of the wheel.

2. The mobile application spin menu as claimed in claim 1 wherein the user can slide his applications (2) to any category disc (3) according to his personal preferences and display slided applications (2) on the disc (3) in pie shape (5).

3. The mobile application spin menu as claimed in claim 1 wherein said mobile application pies (5) are sized enough to display identifiable portions of the icon image (4).

4. The mobile application spin menu as claimed in claim 1 wherein after the new disc (3) is created and categorized, icon images (4) can be slid onto and off the pies (5).

5. The mobile application spin menu as claimed in claim 1 wherein said system and process includes rotating the menu list containing the applications (2) and as disc (3) rotates more applications (2) appear.

6. The mobile application spin menu as claimed in claim 1 wherein the left rotation of the disc (3) provides forward movement of the disc (3) and the right rotation provides backward movement of the disc (3).

7. The mobile application spin menu as claimed in claim 1 wherein the user can avail the option to display the menu discs (3) individually as mini-discs (6) or in stacked format as in the center of the mobile display screen (1).

8. The mobile application spin menu as claimed in claim 1 wherein the menu discs (3) when displayed individually around the main center disc show only the category name.

9. The mobile application spin menu as claimed in claim 1 wherein when the menu discs (3) when stacked on the center, the end-user can slide the top disc off the screen so as to see the ones below it, the slided top disc being placed around the main disc (3) and becoming a mini-disc (6) which when touched comes into focus.

10. The mobile application spin menu as claimed in claim 1 wherein when the user downloads the Spin Menu applications, icon (4) copies of all applications on the mobile terminal will be lined up on the right hand side of a blank disk as and allows the user to scroll up and down the icons (4), and slide the applications (2), create a new category disc (3) on the mobile screen and enter the category name.

11. The mobile application spin menu as claimed in claim 1 wherein the user can load applications (2) onto the disc (3) to create a default application menu.
